(19) United States
(12) Patent Application Publication
(10) Pub. No.: US 2025/0238885 A1
(43) Pub. Date: Jul. 24, 2025

(54) SYSTEM AND METHOD FOR STRATEGIC SOURCING AND VENDOR MANAGEMENT

(71) Applicant: Infinity Loop Technologies Inc., New York, NY (US)

(72) Inventor: Nithin Mummaneni, New York, NY (US)

(73) Assignee: Infinity Loop Technologies Inc., New York, NY (US)

(21) Appl. No.: 19/032,155

(22) Filed: Jan. 20, 2025

Related U.S. Application Data
(60) Provisional application No. 63/623,276, filed on Jan. 21, 2024.

(51) Int. Cl. G06Q 50/18; G06V 30/42

(52) U.S. Cl. CPC G06Q 50/188; G06V 30/42

(57) ABSTRACT

The various embodiments herein provide a system and method for strategic sourcing and vendor management. The embodiments also provide a system and method for enabling automated procurement processes, including negotiation simulation and contract management. The system enables automation of contract analysis, negotiation, and vendor assessment, thereby streamlining the procurement process. The embodiments comprise an OCR-enabled upload for contract variable aggregation, AI-driven negotiation simulation, and vendor sheets for due diligence. The system is designed to identify a plurality of savings opportunities, assist in decision-making, and promote efficient contract management, distinguishing itself as an improvement in enabling reliable and efficient strategic sourcing.

### CROSS-REFERENCE TO RELATED APPLICATIONS

The embodiments herein claim the priority of the U.S. Provisional Patent Application filed on Jan. 21, 2024, with the No. 63/623,276 and titled, “SYSTEM AND METHOD FOR STRATEGIC SOURCING AND VENDOR MANAGEMENT”, the contents of which are incorporated herein by the way of reference.

### BACKGROUND

### Technical Field

The embodiments herein are generally related to business-to-business (B2B) software services. The embodiments herein are specifically related to a system and method for strategic sourcing and vendor management. The embodiments herein are more specifically related to a system and method for enabling automated procurement processes, including negotiation simulation and contract management.

### Description of the Related Art

The current state of B2B procurement is characterized by manual processes that have not significantly evolved in the past fifty years. Companies typically rely on extensive methodologies to identify, research, and source contracts, often requiring assistance from costly consulting firms. These firms, while knowledgeable, essentially employ the same labor-intensive procedures. The existing systems are not only time-consuming but also lack the ability to analyze and leverage data effectively during contract negotiations. Moreover, the manual approach limits the ability to identify savings opportunities, such as co-terming contracts or recognizing price differentiations. Consequently, businesses may not fully optimize their contract terms, leading to suboptimal expenditure management.

Another prevalent problem is the lack of intelligent tools for vendor assessment. Companies must conduct extensive due diligence manually, which is both resource-intensive and prone to oversights. In addition, the vendor selection process is often subjective and lacks a quantitative foundation for comparison, which hampers informed decision-making.

Therefore, there exists a need for an automated and intelligent platform that simplifies and enhances the entire procurement process. There also exists a need for enabling automated contract management and provide negotiation simulation. There also exists a need for enabling intelligent vendor assessment, thereby transforming and modernizing the legacy methods of strategic sourcing and vendor management.

There also exists a need for an automated and intelligent system that leverages artificial intelligence (AI) and machine learning (ML) to minimize human intervention in the procurement process, wherein the system automates key tasks such as vendor selection by using AI to analyze vendor performance data and match them against user-defined business and technical requirements. The system is configured to further enhance efficiency through automated due diligence, where AI scans and processes public and proprietary data to create comprehensive vendor profiles. Additionally, the system automates contract review by applying machine learning models that flag potential contract risks and optimize terms, reducing reliance on manual processes like reviewing legal clauses and compliance checks. According to an exemplary embodiment, the AI-powered contract review automatically extracts and analyzes key contract variables such as pricing, delivery terms, and risk clauses, and wherein, machine learning models then benchmark these against industry standards to generate automated reports that highlight savings opportunities, compliance gaps, and potential risks.

The above mentioned shortcomings, disadvantages and problems are addressed herein and which will be understood by reading and studying the following specification.

### OBJECTIVES OF THE EMBODIMENTS

The primary objective of the embodiments herein is to provide a system and method for strategic sourcing and vendor management.

Another object of the embodiments herein is to provide a system and method for enabling automated procurement processes, including negotiation simulation and contract management.

Yet another object of the embodiments herein is to provide an automated process for uploading and analyzing procurement contracts.

Yet another object of the embodiments herein is to identify opportunities for savings through contract co-terming and SKU price variation.

Yet another object of the embodiments herein is to enable negotiation simulation with best practice prompts for procurement and legal terms.

Yet another object of the embodiments herein is to automate the generation of vendor due diligence reports using artificial intelligence.

Yet another object of the embodiments herein is to facilitate intelligent comparison of vendors based on business and technical requirements.

Yet another object of the embodiments herein is to streamline the management of contract renewals and notifications.

Yet another object of the embodiments herein is to create a comprehensive B2B marketplace for goods and services.

Yet another object of the embodiments herein is to provide an intuitive and interactive platform for spend analysis and vendor management.

Yet another object of the embodiments herein is to reduce reliance on expensive consultancy services for procurement processes.

Yet another object of the embodiments herein is to normalize procurement and negotiation data to reflect macroeconomic trends.

These and other objects and advantages of the embodiments herein will become readily apparent from the following detailed description taken in conjunction with the accompanying drawings.

### SUMMARY

The various embodiments herein provide a system and method for strategic sourcing and vendor management. The embodiments also provide a system and method for enabling automated procurement processes, including negotiation simulation and contract management.

According to one embodiment herein, a system and method for strategic sourcing and vendor management includes digitizing and automating traditional strategic sourcing methods and enabling companies to manage their third-party spend contracts more efficiently. The system comprises an OCR upload functionality for contract analysis, a negotiation simulation with AI-powered suggestions, and AI-generated vendor sheets that facilitate thorough due diligence. The system further comprises a supplier comparison tool, which uses artificial intelligence to match business and technical requirements with potential vendors.

According to one embodiment herein, the system for strategic sourcing and vendor management comprises a plurality of functional modules, including: an OCR upload module that scans key contract variables for analysis and aggregation; a negotiation simulation module that flags saving opportunities and guides users on negotiation tactics; a supplier sheets module that enables AI-generated reports for summarizing essential vendor information; a supplier comparison tool module that matches vendor offerings with user requirements and scores them; an automated purchasing platform module that simplifies the procurement process with automated tools; a price and contract benchmarking module that enables users to assess and compare contract terms; a supplier marketplace that facilitates the discovery and engagement of potential vendors; and, an automated demand planning module that predicts and plans for future procurement needs. The system is configured to activate a plurality of these modules for processing procurement data, simulating negotiation scenarios, generating vendor assessments, and facilitating contract management and vendor comparison.

According to one embodiment herein, a system is provided for procurement contract scoring and optimization. The system includes: an OCR upload module configured to digitize procurement contracts by extracting key variables such as pricing, delivery terms, and risk clauses, and converting them into a structured digital format; a benchmarking module configured to compare extracted contract variables against predefined procurement and legal benchmarks, as well as historical data, industry standards, and macroeconomic trends; a machine learning (ML) module configured to analyze benchmarked contract variables and assign a performance score to the contract based on deal structure attributes, leveraging dynamic weighting algorithms and historical feedback data; an optimization guidance module configured to generate targeted recommendations for improving contract scores by identifying and adjusting specific contract levers, including pricing terms, risk allocation clauses, and compliance metrics; a negotiation simulation module configured to present interactive scenarios that integrate the optimization recommendations, enabling users to test and refine negotiation strategies while receiving real-time feedback on potential cost reductions, risk mitigations, and improved contract scores; and, a user interface module configured to visualize contract scores, benchmarking results, optimization recommendations, and simulated negotiation outcomes, empowering users to achieve cost reduction and risk mitigation through informed contract negotiations and re-negotiations.

According to one embodiment herein, the OCR upload module is further configured to process uploaded contracts using optical character recognition to identify and digitize procurement variables, including pricing, delivery terms, and risk clauses.

According to one embodiment herein, the benchmarking module is further configured to benchmark a plurality of extracted variables by comparing the variables against predefined procurement and legal standards, historical data, and market trends.

According to one embodiment herein, the machine learning module is further configured to use historical data and predefined algorithms to generate a weighted score for each identified contract lever, producing an overall grade for the contract.

According to one embodiment herein, the optimization guidance module is further configured to identify specific contract levers for modification and generate recommendations for improving scoring metrics related to pricing, risk mitigation, and compliance.

According to one embodiment herein, the negotiation simulation module is further configured to simulate negotiation scenarios using the optimization recommendations and provide feedback on potential cost reductions and improved deal outcomes.

According to one embodiment herein, the user interface module is further configured to allow the user to visualize the contract score, benchmarking insights, and simulated negotiation outcomes through an interactive dashboard.

According to one embodiment herein, the system further includes time-series data and historical trends for predicting future outcomes and guiding optimization efforts, providing users of the system with forward-looking insights for proactive contract management.

According to one embodiment herein, a method is provided for scoring and optimizing procurement contracts. The method includes: receiving one or more contracts via an upload interface and processing the contracts using an Optical Character Recognition (OCR) module to extract procurement and legal variables, including pricing terms, delivery schedules, and risk clauses; benchmarking the extracted variables using a benchmarking module to compare the variables against predefined procurement and legal standards, historical data, and market trends; scoring the contract using a machine learning module, wherein the benchmarked variables are analyzed to assign weighted scores to individual contract levers, and an overall performance score or grade is generated for the contract based on its deal structure; generating optimization recommendations using an optimization guidance module, wherein contract levers with suboptimal scores are identified and actionable suggestions for improving the contract score are provided, including adjustments to pricing, delivery terms, and risk mitigation clauses; enabling contract optimization using a negotiation simulation module, wherein the optimization recommendations are integrated into simulated negotiation scenarios, allowing users to test and refine negotiation strategies; providing feedback on the outcomes of the negotiation simulations, including potential cost reductions, risk mitigations, and improved contract scores; and, presenting the optimized contract data and outcomes to a user through a user interface module, wherein the user is enabled to implement the recommendations and achieve enhanced contract terms, cost savings, and risk mitigation.

According to one embodiment herein, the step of receiving one or more contracts further includes: receiving physical or digital contracts via a user interface or system API; processing the contracts using an Optical Character Recognition (OCR) module to detect and extract procurement variables, including pricing structures, payment terms, delivery schedules, risk allocation clauses, and compliance conditions; converting the extracted variables into a structured digital format stored in a centralized repository; and, employing Natural Language Processing (NLP) to ascertain the importance of a particular lever in the contract by industry and supplier, in order to determine the optimal negotiation strength of the contract and providing the best possible recommendation to the buyer to obtain a better outcome.

According to one embodiment herein, the step of benchmarking the extracted variables further includes: comparing each contract lever, such as pricing terms, risk clauses, and service-level agreements, against a repository of historical contract data, industry best practices, and macroeconomic trends; identifying deviations in contract variables from optimal or industry-standard terms; generating detailed benchmarking insights, including potential cost savings, compliance gaps, and, areas for improvement; and tagging each identified deviation with a severity rating to prioritize subsequent optimization efforts.

According to one embodiment herein, the step of scoring the contract further includes: processing the benchmarked variables through a machine learning module trained on historical contract data and industry-specific attributes; assigning weighted scores to individual contract levers based on factors such as pricing efficiency, risk mitigation, compliance level, and delivery performance; calculating an aggregate score or grade for the contract by summing the weighted scores and normalizing them against predefined thresholds; categorizing the overall grade into qualitative performance levels, such as “A−”, “B+”, or “C”; and, refining the scoring algorithm dynamically based on feedback from users and system performance in real-world scenarios.

According to one embodiment herein, the step of generating optimization recommendations further includes: analyzing the scores of individual contract levers to identify low-performing variables with potential for improvement; generating actionable suggestions for each low-performing lever, including renegotiating pricing terms, introducing penalty clauses, or revising delivery schedules; categorizing recommendations based on their expected impact on cost reduction, risk mitigation, and compliance enhancement; presenting a prioritized list of recommendations to the user, highlighting high-impact opportunities; and, providing detailed explanations and justifications for each recommendation, including expected outcomes and feasibility considerations.

According to one embodiment herein, the step of enabling contract optimization further includes: integrating the optimization recommendations into a negotiation simulation module to create virtual negotiation scenarios; simulating multiple negotiation strategies, such as alternative pricing proposals, delivery term adjustments, and risk-sharing clauses; allowing users to interact with the simulations, testing various strategies and combinations of levers; generating real-time feedback on the effectiveness of the strategies, including changes in cost savings, risk exposure, and contract scores; and, iteratively refining the negotiation scenarios based on user inputs and feedback, enabling continuous learning and improvement.

According to one embodiment herein, the step of providing feedback on the outcomes further includes: analyzing the simulated negotiation outcomes using advanced analytics to highlight successful strategies and areas for improvement; generating visual summaries of the potential impacts of recommended changes, including cost reductions, risk mitigations, and improved compliance; providing detailed metrics for each scenario, such as percentage savings achieved, risk scores reduced, and the overall improvement in the contract grade; and, enabling users to compare multiple scenarios and select the most optimal strategy for implementation.

According to one embodiment herein, the step of presenting the optimized contract data and outcomes further includes: displaying the contract score, benchmarking insights, optimization recommendations, and simulated outcomes through an interactive dashboard; enabling users to sort, filter, and prioritize recommendations based on their potential impact, feasibility, or alignment with business goals; providing comparative analyses of the original and optimized contracts to assess the effectiveness of the recommended changes; generating customizable reports summarizing the contract optimization process, including key insights, actions taken, and results achieved; and, supporting real-time updates and notifications to keep users informed of ongoing optimization activities and status changes.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a system for strategic sourcing and vendor management, according to one embodiment herein.

FIG. 2 illustrates a method for enabling automated procurement processes through negotiation simulation, according to one embodiment herein.

Although specific features of the embodiments herein are shown in some drawings and not in others. This is done for convenience only as each feature may be combined with any or all of the other features in accordance with the embodiments herein.

### DETAILED DESCRIPTION OF THE DRAWINGS

In the following detailed description, reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a system and method for strategic sourcing and vendor management. The embodiments also provide a system and method for enabling automated procurement processes, including negotiation simulation and contract management.

According to one embodiment herein, a system and method for strategic sourcing and vendor management includes digitizing and automating traditional strategic sourcing methods and enabling companies to manage their third-party spend contracts more efficiently. The system comprises an OCR upload functionality for contract analysis, a negotiation simulation with AI-powered suggestions, and AI-generated vendor sheets that facilitate thorough due diligence. The system further comprises a supplier comparison tool, which uses artificial intelligence to match business and technical requirements with potential vendors.

According to one embodiment herein, a system is provided for strategic sourcing and vendor management. The system comprises an OCR upload module, a negotiation simulation module, a supplier sheets module, a supplier comparison tool module, an automated purchasing platform module, a price and contract benchmarking module, a supplier marketplace module and, an automated demand planning module. The system is configured to activate a plurality of these modules for processing procurement data, simulating negotiation scenarios, generating vendor assessments, and facilitating contract management and vendor comparison. The system is further configured to enable suppliers and sellers to access the plurality of modules in the system, wherein the suppliers and sellers are enabled context-aware access to all the features and functionalities as the buyers.

According to one embodiment herein, an OCR upload module is provided. This module is designed to digitize physical contract documents by converting them into editable and searchable text. The module includes imaging sensors configured with Optical Character Recognition (OCR) technology, which are configured to scan physical documents and read the text from scanned PDFs or images uploaded to the system. Once the text is extracted, it is stored in a structured digital format for further analysis.

According to one embodiment herein, a negotiation simulation module is provided. The module provides a simulated environment to assist human users practice and refine their negotiation skills. The module utilizes historical data, market trends, and predefined negotiation parameters to create realistic scenarios. The users are enabled to interact with the simulation to test different negotiation strategies and receive feedback and suggestions for improvement.

According to one embodiment herein, a supplier sheets module is provided. The module is configured to compile comprehensive profiles for vendors, including financial, operational, and compliance information. The module automatically gathers data from a plurality of sources, including social media, financial records, and other databases, to create detailed reports that inform the due diligence process.

According to one embodiment herein, a supplier comparison tool module is provided for evaluating and comparing potential suppliers against a set of business and technical criteria. The tool is configured to score and rank vendors based on the criteria specified by the user, such as price, quality, delivery time, and service levels. The comparisons are displayed in an easy-to-understand format, aiding decision-making.

According to one embodiment herein, an automated purchasing platform module is provided for simplifying the procurement process through automation. The module is configured to integrate with a plurality of ERP systems and utilize predefined purchasing parameters, and for autonomously initiating purchase orders, tracking deliveries, and managing inventory levels.

According to one embodiment herein, a price and contract benchmarking module is provided for enabling users to compare contract terms and prices against a database of industry standards and previous contracts. The module is also configured to analyze extracted contract data against a repository of market data to highlight improvement areas in the contract.

According to one embodiment herein, a supplier marketplace module is provided for facilitating the discovery of new suppliers and the expansion of a user's vendor network. The marketplace is configured to operate as a two-sided platform, where suppliers are enabled to list their offerings, and buyers are enabled to browse, search, and initiate contact with potential new vendors. The marketplace module is designed to be configured in a plurality of user devices in form of digital applications, wherein the digital applications are further supported by a plurality of human-machine interfaces including audio-visual, textual, Extended Reality and a plurality of other interfaces for enabling input-output between the users and the marketplace module.

According to one embodiment herein, an automated demand planning module is provided. The module is configured to predict future procurement needs based on historical consumption data and forecasting algorithms. The module is configured to assess past usage patterns, inventory turnover rates, and market trends to forecast future demand, thereby helping businesses to plan their procurement activities proactively.

According to one embodiment herein, a method is provided for strategic sourcing and vendor management. The method includes: gathering relevant data from various sources, including previous contracts, market trends, and vendor performances, wherein the data serves as the factual foundation for the negotiation scenarios; users inputting specific goals and parameters for their negotiation, which includes the type of contract, target prices, deadlines, and other strategic factors, and wherein, these inputs allow the system to customize the simulation to reflect the user's negotiation context; with the user's parameters, the simulation engine activates and processes the aggregated data, and wherein, the engine uses algorithms to create a virtual negotiation environment tailored to the user's inputs; within the simulated environment, multiple negotiation scenarios are generated, and wherein, these scenarios represent possible paths the negotiation could take, providing a range of experiences to the user; the user interacts with the generated scenarios through a user interface, where they apply negotiation strategies and make decisions, and wherein, the user's choices during the simulation affect the direction and outcome of the negotiation; after each simulation, the system provides the user with feedback on their performance, and wherein, analytics are presented to highlight effective strategies, areas for improvement, and how the user's choices aligned with best practices; possible outcomes of the negotiations are provided based on the user's strategies and the data-driven simulation, and wherein, these projections help the user understand potential results of their negotiation approaches; and, users repeat the simulation with different parameters and strategies, learning from feedback and refining their negotiation skills, and wherein, the system adapts to the user's learning curve, offering increasingly sophisticated scenarios and feedback to continually challenge and develop the user's abilities.

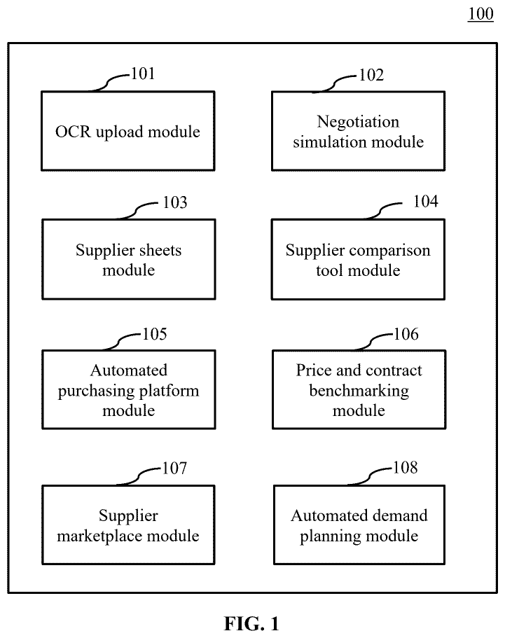

FIG. 1 illustrates a system for strategic sourcing and vendor management. The system includes an OCR upload module 101, a negotiation simulation module 102, a supplier sheets module 103, a supplier comparison tool module 104, an automated purchasing platform module 105, a price and contract benchmarking module 106, a supplier marketplace module 107 and, an automated demand planning module 108.

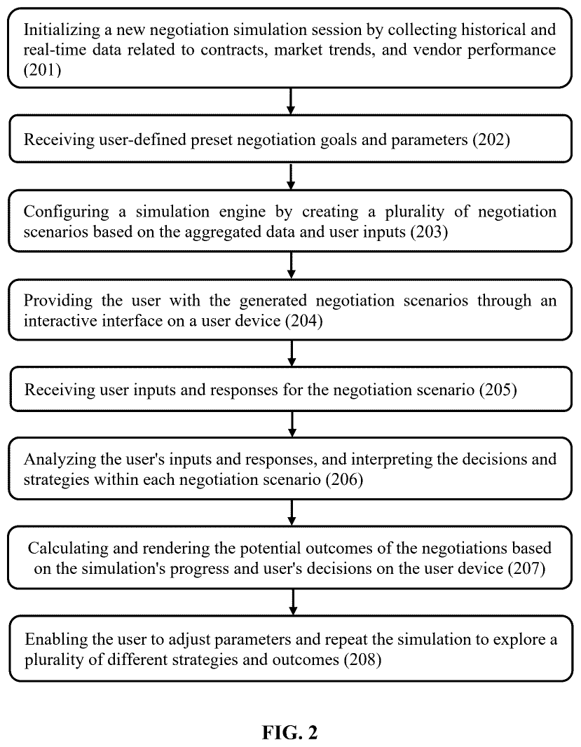

FIG. 2 illustrates a method for enabling automated procurement processes through negotiation simulation. The method includes: initializing a new negotiation simulation session by collecting historical and real-time data related to contracts, market trends, and vendor performance (201); receiving user-defined preset negotiation goals and parameters (202); configuring a simulation engine by creating a plurality of negotiation scenarios based on the aggregated data and user inputs (203); providing the user with the generated negotiation scenarios through an interactive interface on a user device (204); receiving user inputs and responses for the negotiation scenario (205); analyzing the user's inputs and responses, and interpreting the decisions and strategies within each negotiation scenario (206); calculating and rendering the potential outcomes of the negotiations based on the simulation's progress and user's decisions on the user device (207); and, enabling the user to adjust parameters and repeat the simulation to explore a plurality of different strategies and outcomes (208).

The various embodiments herein provide a system and method for strategic sourcing and vendor management. The embodiments also provide a system and method for enabling automated procurement processes, including negotiation simulation and contract management. The system provides AI-driven analysis and simulation tools that enable users to make more informed decisions, negotiate better terms, and identify saving opportunities more effectively. The system reduces the time and effort that is to be provided by seasoned and experienced professionals in the field of sourcing, vendor management, negotiation and contract management. The system also removes the constraint of the availability of experts with consulting expertise, including in the domains of strategy and operating model consulting. The system enables users to save significant time and effort and provides verifiable and quantifiable metrics for negotiating B2B deals.

Although the embodiments herein are described with various specific embodiments, it will be obvious for a person skilled in the art to practice the embodiments herein with modifications.

The foregoing description of the specific embodiments will so fully reveal the general nature of the embodiments herein that others can, by applying current knowledge, readily modify and/or adapt for various applications such as specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims.

1. A system for procurement contract scoring and optimization, the system comprising:
an OCR upload module configured to digitize procurement contracts by extracting key variables such as pricing, delivery terms, and risk clauses, and converting them into a structured digital format;
a benchmarking module configured to compare extracted contract variables against predefined procurement and legal benchmarks, as well as historical data, industry standards, and macroeconomic trends;
a machine learning (ML) module configured to analyze benchmarked contract variables and assign a performance score to the contract based on deal structure attributes, leveraging dynamic weighting algorithms and historical feedback data;
an optimization guidance module configured to generate targeted recommendations for improving contract scores by identifying and adjusting specific contract levers, including pricing terms, risk allocation clauses, and compliance metrics;
a negotiation simulation module configured to present interactive scenarios that integrate the optimization recommendations, enabling users to test and refine negotiation strategies while receiving real-time feedback on potential cost reductions, risk mitigations, and improved contract scores; and,
a user interface module configured to visualize contract scores, benchmarking results, optimization recommendations, and simulated negotiation outcomes, empowering users to achieve cost reduction and risk mitigation through informed contract negotiations and re-negotiations.

2. The system according to claim 1, wherein the OCR upload module is further configured to process uploaded contracts using optical character recognition to identify and digitize procurement variables, including pricing, delivery terms, and risk clauses.

3. The system according to claim 1, wherein the benchmarking module is further configured to benchmark a plurality of extracted variables by comparing the variables against predefined procurement and legal standards, historical data, and market trends.

4. The system according to claim 1, wherein the machine learning module is further configured to use historical data and predefined algorithms to generate a weighted score for each identified contract lever, producing an overall grade for the contract.

5. The system according to claim 1, wherein the optimization guidance module is further configured to identify specific contract levers for modification and generate recommendations for improving scoring metrics related to pricing, risk mitigation, and compliance.

6. The system according to claim 1, wherein the negotiation simulation module is further configured to simulate negotiation scenarios using the optimization recommendations and provide feedback on potential cost reductions and improved deal outcomes.

7. The system according to claim 1, wherein the user interface module is further configured to allow the user to visualize the contract score, benchmarking insights, and simulated negotiation outcomes through an interactive dashboard.

8. The system according to claim 1, wherein the system further includes time-series data and historical trends for predicting future outcomes and guiding optimization efforts, providing users of the system with forward-looking insights for proactive contract management.

9. A method for scoring and optimizing procurement contracts, the method comprising:
receiving one or more contracts via an upload interface and processing the contracts using an Optical Character Recognition (OCR) module to extract procurement and legal variables, including pricing terms, delivery schedules, and risk clauses;
benchmarking the extracted variables using a benchmarking module to compare the variables against predefined procurement and legal standards, historical data, and market trends;
scoring the contract using a machine learning module, wherein the benchmarked variables are analyzed to assign weighted scores to individual contract levers, and an overall performance score or grade is generated for the contract based on its deal structure;
generating optimization recommendations using an optimization guidance module, wherein contract levers with suboptimal scores are identified and actionable suggestions for improving the contract score are provided, including adjustments to pricing, delivery terms, and risk mitigation clauses;
enabling contract optimization using a negotiation simulation module, wherein the optimization recommendations are integrated into simulated negotiation scenarios, allowing users to test and refine negotiation strategies;
providing feedback on the outcomes of the negotiation simulations, including potential cost reductions, risk mitigations, and improved contract scores; and,
presenting the optimized contract data and outcomes to a user through a user interface module, wherein the user is enabled to implement the recommendations and achieve enhanced contract terms, cost savings, and risk mitigation.

10. The method according to claim 9, wherein the step of receiving one or more contracts further includes: receiving physical or digital contracts via a user interface or system API; processing the contracts using an Optical Character Recognition (OCR) module to detect and extract procurement variables, including pricing structures, payment terms, delivery schedules, risk allocation clauses, and compliance conditions; converting the extracted variables into a structured digital format stored in a centralized repository; and, employing Natural Language Processing (NLP) to ascertain the importance of a particular lever in the contract by industry and supplier, in order to determine the optimal negotiation strength of the contract and providing the best possible recommendation to the buyer to obtain a better outcome.

11. The method according to claim 9, wherein the step of benchmarking the extracted variables further includes: comparing each contract lever, such as pricing terms, risk clauses, and service-level agreements, against a repository of historical contract data, industry best practices, and macroeconomic trends; identifying deviations in contract variables from optimal or industry-standard terms; generating detailed benchmarking insights, including potential cost savings, compliance gaps, and, areas for improvement; and tagging each identified deviation with a severity rating to prioritize subsequent optimization efforts.

12. The method according to claim 9, wherein the step of scoring the contract further includes: processing the benchmarked variables through a machine learning module trained on historical contract data and industry-specific attributes; assigning weighted scores to individual contract levers based on factors such as pricing efficiency, risk mitigation, compliance level, and delivery performance; calculating an aggregate score or grade for the contract by summing the weighted scores and normalizing them against predefined thresholds; categorizing the overall grade into qualitative performance levels, such as “A−”, “B+”, or “C”; and, refining the scoring algorithm dynamically based on feedback from users and system performance in real-world scenarios.

13. The method according to claim 9, wherein the step of generating optimization recommendations further includes: analyzing the scores of individual contract levers to identify low-performing variables with potential for improvement; generating actionable suggestions for each low-performing lever, including renegotiating pricing terms, introducing penalty clauses, or revising delivery schedules; categorizing recommendations based on their expected impact on cost reduction, risk mitigation, and compliance enhancement; presenting a prioritized list of recommendations to the user, highlighting high-impact opportunities; and, providing detailed explanations and justifications for each recommendation, including expected outcomes and feasibility considerations.

14. The method according to claim 9, wherein the step of enabling contract optimization further includes: integrating the optimization recommendations into a negotiation simulation module to create virtual negotiation scenarios; simulating multiple negotiation strategies, such as alternative pricing proposals, delivery term adjustments, and risk-sharing clauses; allowing users to interact with the simulations, testing various strategies and combinations of levers; generating real-time feedback on the effectiveness of the strategies, including changes in cost savings, risk exposure, and contract scores; and, iteratively refining the negotiation scenarios based on user inputs and feedback, enabling continuous learning and improvement.

15. The method according to claim 9, wherein the step of providing feedback on the outcomes further includes: analyzing the simulated negotiation outcomes using advanced analytics to highlight successful strategies and areas for improvement; generating visual summaries of the potential impacts of recommended changes, including cost reductions, risk mitigations, and improved compliance; providing detailed metrics for each scenario, such as percentage savings achieved, risk scores reduced, and the overall improvement in the contract grade; and, enabling users to compare multiple scenarios and select the most optimal strategy for implementation.

16. The method according to claim 9, wherein the step of presenting the optimized contract data and outcomes further includes: displaying the contract score, benchmarking insights, optimization recommendations, and simulated outcomes through an interactive dashboard; enabling users to sort, filter, and prioritize recommendations based on their potential impact, feasibility, or alignment with business goals; providing comparative analyses of the original and optimized contracts to assess the effectiveness of the recommended changes; generating customizable reports summarizing the contract optimization process, including key insights, actions taken, and results achieved; and, supporting real-time updates and notifications to keep users informed of ongoing optimization activities and status changes.
